(19) United States
(12) Patent Application Publication
(10) Pub. No.: US 2007/0192138 A1
(43) Pub. Date: Aug. 16, 2007

(54) Medical record system in a wide-area network environment

(76) Inventors: Motoaki Saito, Tokyo (JP); Kazuo Takahashi, Tokyo (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/356,542

(22) Filed: Feb. 16, 2006

(51) Int. Cl. G06F 19/00; H04K 1/00

(52) U.S. Cl. 705/3; 380/255

(57) ABSTRACT

High speed data processing devices are set up near a PACS server network which stores medical image data. Devices for preparation of electronic medical reports, attached to electronic medical reports image processing parameters together with image data information, are used during an image diagnosis. Terminal devices for browsing electronic medical reports use information attached to electronic medical report and image processing parameters are sent with information for acquisition of image data to data processing devices near a PACS server in which this image data is stored. The data processing devices acquire image data based on this information with the parameters, image processing is performed and the created images are sent to terminal devices. In addition, the acquisition and displaying of related information is also performed in the same manner. This enables processing and display interactively of images and information related to electronic medical records at a terminal device.

### FIELD OF THE INVENTION

At least one embodiment of the present invention pertains to a system that uses medical image data, which makes it possible to create and access electronic records in a wide area network by using the Internet or other network or networks.

### BACKGROUND

Much progress has been achieved in the design of electronic systems for diagnostic records called electronic medical records. Electronic medical records can be made from not only diagnostic records, but also data from headboard records, data from blood test records and similar diagnostic information, which can be recorded in electronic format. When these diagnostic records, image diagnostic records, headboard records, blood test data and other diagnostic information about patients are recorded and collected in an electronic medical record, this makes it possible to prevent occurrences of double testing.

Electronic medical records are normally stored in electronic files on a server of a hospital information system (HIS) of a medical treatment institution in which the diagnosis of a patient is performed. In this case, the electronic medical records of some patients are present in each medical institution that a given patient is visiting. Most recently, there have been attempts to store electronic medical records off-line on a recording medium, which has a security function using IC cards and similar equipment. Because in this case, electronic medical records are stored sequentially on IC cards for individual patients, this makes it possible to consult the medical history in past diagnoses by perusing electronic medical records created at medical treatment institutions up until the time when a patient visited such an institution, even if the patient who in the past was visiting a medical treatment institution was then admitted for a diagnosis to another medical treatment institution.

The information relating to medical treatment of patients is very important information, as it relates to examinations using medical images. The examination of medical images is generally performed in image examination departments with devices such as X-ray devices, X-ray computed tomography (CT) devices, nuclear medicine diagnosis devices, ultrasound examination devices, endoscopes and similar medical image devices.

In many cases, medical images collected with image diagnosis devices are interpreted by doctors who specialize in the diagnosis of medical images and who perform a so called image diagnosis. The results of the image diagnosis are then described in an image diagnosis report and sent to requesting departments.

In the past, X-ray images taken with an X-ray machine were viewed on a film and then digitized with an X-ray CT device or the like and collected with a medical imaging diagnostic device so that these medical images could be observed also printed on a film. Most recently, however, in order to improve storage and distribution of medical images, such data has been stored as digital data on a server and distributed to image display devices via a network as required, while picture archiving communication systems (PACS) have been introduced enabling observation of this data.

The results of an interpretation performed by medical image specialists were in the past handwritten on forms of written image diagnosis reports and distributed to departments that requested this information. Word processed files and the like have also been used instead of handwritten information, which can be also printed on paper. In such cases, the image information representing the basis for the image diagnoses was sketched by hand in a form called schema, incorporated in a written image diagnosis report, and transmitted from an image diagnosis specialist to a requesting department. Most recently, personal computers have been used to create and store image diagnosis reports and increasingly, these reports are sent in many cases to requesting departments by a medical information system (hereinafter “HIS”). In this case, the image diagnosis reports are stored as electronic files in personal computers and either sent to terminal computers in requesting departments, or they are sent with e-mail. In these cases, in order to reduce the amount of data that is sent through a network, the size of images that are based on diagnostic data is reduced, and also the density resolution of these images is reduced so that a greatly reduced number of pages containing images will then be attached to an image information report. For example, although several hundred pages to several thousand pages can be generated using 512×512 image elements and an image data depth of 16 bits with one scan performed with the latest X-ray CT scans, also in such a case, only about one to two pages of images with 256×256 image element and an image data depth of 8 bits will be attached.

Also, when three-dimensional images are created with the latest X-ray CT scans or MRI scans, image diagnosis operations are now for the first time performed when these three-dimensional images are performed. Because when three-dimensional images are displayed as stereoscopic images, the angle of observation can be set by changing the direction of visual observation in an interactive manner, very useful information such as a surgical image or the like can be provided not only to image diagnosis specialists, but also to plastic surgeons in a requesting department. However, because an enormous amount of data is created, this makes it difficult for doctors who work in requesting departments to create three-dimensional data. Moreover, since only about one to two pages of two-dimensional images were attached, even though some data was taken with a three-dimensional angle for attachment of three-dimensional images to image diagnosis reports, three-dimensional images have not been very useful as they haven not been used very actively in requesting departments.

The reason why the usage of images has been limited in requesting departments is the fact that it has not been possible to provide sufficient data to requesting departments from the image diagnosis department, because the bandwidth of the network connecting the image diagnosis department with the requesting departments was too narrow. Because a hospital will generally have many requesting departments, also the number of the computers which are used by the terminal users has grown dramatically. That is why it has been in many cases difficult to create a high speed network for the computers at all the user terminals.

In addition to diagnostic information, image diagnostic information is also recorded in electronic medical records. When electronic medical records are distributed through a network, the number of pages of images that can be attached to an electronic medical record is limited from the viewpoint of the traffic in the network. In addition, when off-line recording medium such as an IC card which has a security function is used as a recording medium for electronic records, the number of pages of images that can be attached to an electronic medical record is again limited by the storage capacity of this recording medium.

Due to the cooperation achieved recently in major hospitals and diagnostic institutions, these staff hospitals have been entrusted with medical image examinations of patients who come to the diagnostic institutions. In these cases, the patients who come to diagnostic institutions are examined with image examinations performed by image specialists in a major hospital who create an image diagnosis report. These image diagnosis reports are then burnt onto a film or the like and sent as medical images also to the original diagnostic institution. The doctors at the original requesting institution then make a determination about the status of the disease of a patient, based on medical images that have been burnt onto films and based on image diagnostic reports that have been sent from a major hospital.

Due to the progress achieved recently in networks such as wide area networks, it has become possible to connect medical institutions to a wide area network. When a diagnostic institution and a major hospital were connected to a wide area network in the past, the data which was stored when patients visited a diagnostic institution was used, and requests for observation of this data were made when there was a need to examine the data created at the diagnostic institution, or when there was a need to observe three-dimensional images. However, because under the current conditions, the bandwidth of a wide area network such as the Internet is still narrow, these requests were hardly ever met because it was basically impossible to transmit large amounts of data for examination of medical data from a hospital to a diagnostic institution.

FIG. 1 is a block diagram showing an image diagnosis device for a main hospital and a diagnostic location according to the prior art, equipped with a data storage device, image processing and displaying device, and its network environment. Reference numeral 101 indicates a wide area network such as the Internet; 111, 112, 113, 114 are main hospitals; and 115 denotes a diagnostic location. Reference numeral 116 denotes a data center, such as a center for storage of image data. Main hospitals 111, 112, 113, 114, the diagnostic location 115, and the image data storage center 116 are connected to the wide area network 101. Reference numeral 131 denotes a connection device connected via an internal wide area network to hospitals, diagnostic stations, and to an image data storage center. Reference numeral 133 denotes a data storage device, which stores medical image data by using an image storage communication system (PACS) or the like, and reference numeral 134 denotes an image network. Reference numerals 141 and 142 indicate examples of image diagnosis devices.

Reference numerals 151, 152 denote examples of image processing and displaying devices. An X-ray CT machine 141, being one example of an imaging diagnostic device, collects X-ray data from a plurality of profiles of a patient and image data is thus created with these multiple profiles when image reconstruction processing is applied to this projection data. A data storage device 133, being a PACS server, collects data with a plurality of imaging diagnostic devices, starting with the X-ray CT device 141, and stores image data containing reconstructed images so that the data can be transmitted to users as required. Network 134 is a large capacity, high speed network which transmits large amounts of image data from the X-ray CT device 141 to the PAC server 133. An image processing and displaying device 151 receives via network 132 image data which is stored by the X-ray CT device 141 or by the PACS server 133, so that this data is used to create two-dimensional, three-dimensional, or four-dimensional images. A medical doctor who is an image diagnosis specialist performs image diagnostic operations by using data obtained from the image processing and displaying device 151, X-ray CT device 141, or image data obtained via the network 132 from the PACS server 133, and this data is used for image processing operations and observation applied to two-dimensional images, as well for image processing operations, and image viewing and image creating operations applied to three-dimensional images and four dimensional images.

An image diagnosis specialist performs image processing and observation of two-dimensional images by using the image processing and displaying device 151, creates three-dimensional and four-dimensional images and views the images so that an image diagnosis report is created based on the findings obtained with these operations. At this time, images are attached to the image diagnostic report based on the findings of the image diagnostic report. As was explained above, approximately one or two pages of images having 256×256 image elements and a depth of 8 bits are attached to an image diagnostic report. In addition, even in cases when three-dimensional images are created and an image diagnosis is conducted, the image data that can be added to an image report corresponds to about one or two pages of two-dimensional images, with some projection onto the plane of three-dimensional images. Image diagnosis reports created by a medical image specialist are then either distributed to requesting departments through an internal hospital network if this is requested by a party in the same hospital, or they can be also distributed as reports printed on paper. If the requesting party is in a different medical treatment institution, the reports are either distributed so that they are sent to the requesting institution via a wide area network such as the Internet, or mailed as copies printed on paper.

As shown in FIG. 1, when a request origination institution is set up so that if the doctors in charge at the institution where a request originated 115 want to access image data that is stored at a data storage device 133 of a main hospital 111 which is entrusted with image examination operations, an image processing and displaying device 151 of the original requesting institution 115 is operated. Access can be attempted either from a PACS sever 133 of a request destination institution 111 through a wide area network 101, for example the Internet, or it can be requested that the image data be transmitted by the institution where a request originated from the PACS server 133 of the request destination hospital 111 to the person in charge at the request destination hospital 111 by using e-mail, with a letter, etc. In either case, because there will be often problems relating to issues such as security and protection of privacy, the access will not be permitted in many cases. Moreover, because it is technically difficult to greatly increase the traffic in the network by transmitting large amounts of image data through the wide area network 101 such as the Internet, this option is not desirable.

In response to these problems, an image data storage center 116 has been created as a concept that takes fully into consideration security and protection of privacy on a wide area network, so that image data collected by institutions of medical treatment could be stored here. However, even in this case, when large amounts of image data are transmitted through a wide area network such as the Internet or the like, it is difficult to resolve issues relating to increased traffic in the network. In addition, the costs of the operations and the costs of the architecture of the image data storage center have been greatly increased.

There have been attempts in the past to record all image data from medical examinations obtained when patients receive a diagnosis at a method treatment facility on a transportable type of recording medium for individual patients. However, since the amount of data represented by image data from medical image scans is thus greatly increased, even if a recording medium is used which has a large capacity, such a medium will be quickly filled up. And although it is possible to record on portable recording medium a great number of images sequentially, this has not been attempted successfully, because this option again gives rise to security issues due to the fact that a great number of portable recording media copies would necessitate protection of privacy.

With the progress achieved in the cooperation between hospital and diagnostic locations, the examination of medical images of patients who visit diagnostic locations has been entrusted to main hospitals. In addition, it is also desirable to use data obtained from examination of medical images performed in the past by multiple institutions of medical treatment by the introduction of an electronic system of medical records, etc. Moreover, there is also a strong demand that medical image data should be used not only in the same institution of medical treatment, but also in a range of institutions for medical treatment. Also, since the number of pages of images that could be recorded in an electronic medical record is limited, it is also necessary to find a means enabling to acquire image data which could not be stored in an electronic medical record when many images were obtained for medical image examination of a patient. Incidentally, patients sometime visit a medical institution without first making an appointment for a visit, even in cases when they do not necessarily have a visit scheduled at the hospital. Although it would be desirable to have medical image data which has been stored at another institution of medical treatment available immediately when such cases arise, even if for example medical image data of a given patient is stored online on a PACS server or the like, a greatly increased network traffic leads to difficulties because a long time period is needed for transmission and acquisition of data through a wide area network such as the Internet. In addition, even though it would be conceivable to record image examination data of a patient on a large capacity recording medium and then mail it, this would take a long time. Therefore, attempts to acquire medical image data from other medical treatment institutions have not been successful mainly due to practical reasons relating to the required time.

### SUMMARY

In order to resolve the issues described above, a high speed data processing device is set up near a PACS server network. When this data processing device acquires image data from a PACS server based on instructions obtained from a personal computer which is used to peruse and create electronic medical records, images are created by applying two-dimensional processing operations to the original image, or three-dimensional processing operations to the original image, so that this image data is sent to a personal computer enabling to browse and create an electronic medical record containing this images. When these images are displayed on personal computers which are used to browse and create electronic medical records, while key images containing image diagnoses are attached to an electronic medical record, this makes it possible to recreate these key images at a later time, so that the key images can be attached with a set of parameters for image processing of information relating to image data. These created electronic medical records are then sent to institutions that requested an examination of medical images either online through a network, or they can be sent by mail, etc.

The doctors in the institution where the request originated browse electronic medical records by using a personal computer, which can be used for browsing and preparation of electronic medical records when connected to a wide area network such as the Internet, and the medical image data of the patients, which is stored in a PACs server, is attached to electronic medical records by a nearby data processing device, while sets of image processing parameters are sent together with the information relating to the image data. The data processing device reads image data specified by a PACS server based on the information relating to the specified image data, images are created with image processing operations applied to create two-dimensional, three-dimensional, and four-dimensional images with this specified imaged data based on a the set of specified image processing parameters, and the created images are sent to personal computers which can be used to browse and create electronic medical records containing images created in this manner. Personal computers for browsing and preparation of electronic medical records also display together with electronic medical records images that have been sent from a data processing server, and play a role important for the understanding of the electronic medical records. Personal computers can be also used at user terminals in order to modify image processing parameters as required; these modified parameters are then sent to a data processing server, image processing operations are performed by the data processing server with these modified image processing parameters, and the result is sent to personal computers for browsing and created of electronic medical records.

Although in the past, it was possible to browse some one or two pages of images which were attached to an electronic medical record at the institution where the request originated, it was not possible, in realistic terms, to obtain in real time data of medical image examinations conducted at the request destination institution. With this invention, however, when electronic medical records are browsed at the institution where a request originated, a set of image processing parameter is sent together with the information relating to image data attached to an electronic medical record from a personal computer for browsing and preparation of electronic medical records to a data processing device at the request destination institution. When the data processing device receives this data, image data is acquired from a PACS server, images are created with these image data processing operations, and these images as sent to personal computers for browsing and preparation of electronic medical records at the institution where the request for these images originated. Personal computers for browsing and preparation of electronic medical records at the institution where a request originated receive the images resulting from these image processing operation and display these images. In addition, because modified image processing parameters are transmitted to data processing device of request destination institutions, this makes it possible to receive in an interactive manner images which have been processed with image processing operations using different image processing parameters. Accordingly, this also makes it possible to achieve a deeper understanding of the content of image diagnosis reports.

Therefore, when image processing of image examination data needed to be done at the institution where a request originated in the past, all the image examination data had to be acquired from the request destination institution. For practical reasons, it would have been impossible to use Internet or another wide area network for transmission of image examination data that was transmitted between the request destination institution, where the image data was stored, and external departments of the institution where a request originated due to problems connected with the traffic on the network. With the present invention, it is not necessary to transmit the image examination data which is stored at the request destination institution to external departments of the institution where a request originated, because when the information specifying the image data and parameters for image processing are transmitted and image processing of the data is processed, the resulting images are received, and this is sufficient even for processing of images using medical image data containing a great amount of data such as data needed for processing of three-dimensional or four-dimensional images using image data collected with a multi-slice X-ray CT device, which can be easily realized by using a wide area network, for instance Internet.

Since in the past, it was basically impossible to use workstations for processing of images enabling to perform processing of three-dimensional images, and because special know-how was needed to create three-dimensional images, these operations had to be performed by specialists in a radiological department. Therefore, it was basically impossible to use three-dimensional images in diagnostic locations, although a major effect could be expected from such a use, such as providing a clear explanation to the patient, as these images could be used only in image diagnosis departments of major hospitals. With this invention, however, a quick progress of the application of three-dimensional images can be expected.

When a user at the request origination institution clicks on a key image attached to an electronic medical report, a set of image processing parameters is sent together with the information relating to the image data from a personal computer for browsing and preparation of electronic medical reports to a request destination institution. For example, when three-dimensional data containing X-ray CT image data is browsed, the specification of parameters such as X-ray CT data used to create three-dimensional images can be sent together with the specification of parameters such as empty regions in the object or the CT value range and the like, as well as projection processing parameters used to display three dimensional images. When a data processing device receives the specified image data from a PACS server, three dimensional images are created with three-dimensional image processing operations applied to the image data by using the indicated set of image processing parameters and the images are then transmitted to a personal computer at the request origination location. The user where the request originated will then display the image on a personal computer for browsing and preparation of electronic medical records. While these images are being browsed at a personal computer for browsing and preparation of electronic medical records, image processing parameters are changed in an interactive manner and sent to a data processing device. The data processing device performs image processing by using these updated image processing parameters to create images, and because these created images are sent to user terminals, the users at the terminals where the request originated can perform image processing operations in the same manner as at the original workstation, as if they were also using a personal computer.

Because a set of image processing parameter can include, for example, the process with which three-dimensional images are created by a specialist at a radiology department, these images can be observed, for example, when a doctors' meeting is being held at the institution where a request originated during which three-dimensional images are created by doctors who are specialists in radiology. Because these radiology specialists can compare one sheet of created three-dimensional images to images sent to the institution where a request originated attached to an electronic medical file containing one particular scene, mutual understanding and communication between the doctors working at the radiology department and consulting doctors who work at the request origination department can be markedly improved, making it possible to improve the understanding of the situation on the part of the consulting doctors.

According to the embodiments of the present invention, personal computers used for browsing and creating electronic medical report are provided with a function to enable addition of key information to key images of electronic medical records containing information processing parameters and image processing parameter, together with information enabling the obtaining of medical information data containing these images, when key information is attached to reports, together with key images containing key information useful to a requesting party requesting information such as medical history, physical examinations, or image scans performed in the past and used to perform an image diagnosis by doctors or related information. Personal computers used for browsing and creating electronic medical records are therefore provided with a function to enable transmission to data processing devices sets of parameters for information processing and for processing of images that have been added and modified based on a number of parameters used to construct a set of parameter for information processing and for processing of images, when image data an medical information data is acquired and added as key information and as key images at the point when this information is consulted in reports by the users of the system. Because the data processing devices acquire image data from a PACS server based on a sets of parameters for image processing and for information used to acquire received image data, this image data is processed and images are created with a function added by personal computers for browsing and creating of electronic medical records containing these images, and with a function to enable transmission to user terminal devices this specified added processing, when data representing medical treatment information is obtained form HIS based on a set of information processing parameters, together with received information for acquisition of medical treatment data. This makes it possible to display in an interactive manner medical treatment information relating to the key information and the images which are related to this key information, attached to reports by personal computers used to browse and create electronic medical records.

According to this invention, image scans obtained with various types of image diagnosis devices can be obtained, in addition to other information related to key images representing key information for image diagnosis, as well as image examinations from past examinations or image scans, image data such as medical history, or medical treatment information and similar data can be obtained from electronic medical records.

Significant effort is required to collect this medical image data and medical treatment information data during an image diagnosis. For example, in hospitals which do not maintain a complete image management system, and which obtain image data from respective image management systems controlled for example with CT scans, MR scans, and DSAM scans, as well as from file storage containing image scans performed in the past, data from physical examinations is obtained from HIS and images from the physical examinations are interpreted, but once the interpretation of the images is finished, the accumulated results are dispersed again. According to this invention, image diagnosis specialists can summarize electronic medical records to create a means that makes it possible to acquire at a later time information determined as important from the information collected in this manner. According to this invention, when electronic medical records are browsed, not only users at the institution where a request originated, but also other specialists in image diagnosis, as well as the actual doctors who perform image diagnosis and who have created the image diagnosis reports can have in their hands important information relating to their patients immediately and at any time. In addition, since it is also possible to collect in a short period of time information such as medical history, physical examinations, and image examinations performed in the past, as this is required in order to interpret images while using these image diagnosis reports with respect to image examinations of patients who are likely to be examined in the future, such a system is important not only from the viewpoint of the operational management of a hospital, but it is very effective also from the economical viewpoint.

When electronic medical records are recorded sequentially in a diagnostic record at a medical treatment institution in which patients are diagnosed, for example on a portable recording medium such as an IC card, which the patient can keep in his or her possession, the electronic medical record can be referenced for a diagnosis received at the time when the patient in question visited another hospital and received a diagnosis at that institution in the past. According to this invention, data relating to examinations received at another medical treatment institution which uses the present invention can be accessed by simply clicking on key information, or key images attached to an electronic medical record at the time when a diagnosis was received by the patient in the past at another medical treatment institution which uses the present invention, so that these images or this medical treatment information can be displayed. Therefore, since it is not necessary to perform another image examination or another physical examination of a patient once this patient has been transferred to another hospital, the invention also plays a role with respect to decreased exposure of patients to medical interventions, which makes it possible to improve the economical characteristics of medical treatment.

Other aspects of the invention will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 illustrates a conventional system for browsing of medical images;

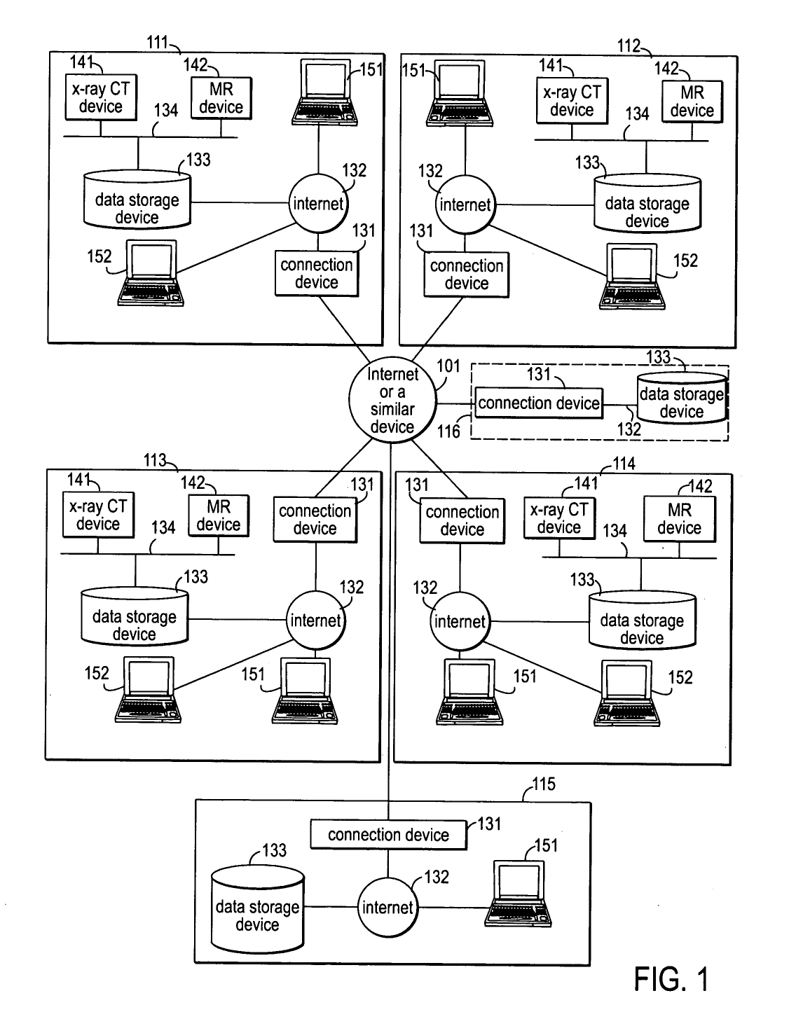

FIG. 2 illustrates a system utilizing medical image data for browsing and preparation of electronic medical records in a wide area network in accordance with the present invention;

FIG. 3A is a flow diagram showing operations performed when electronic medical records are browsed by a user at the request origination in accordance with the prior art; and

FIG. 3B is a flow diagram showing operations performed when electronic medical records are browsed by a user at the request origination in accordance with the present invention.

### DETAILED DESCRIPTION

A medical record system for use in a wide-area network environment is described. References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

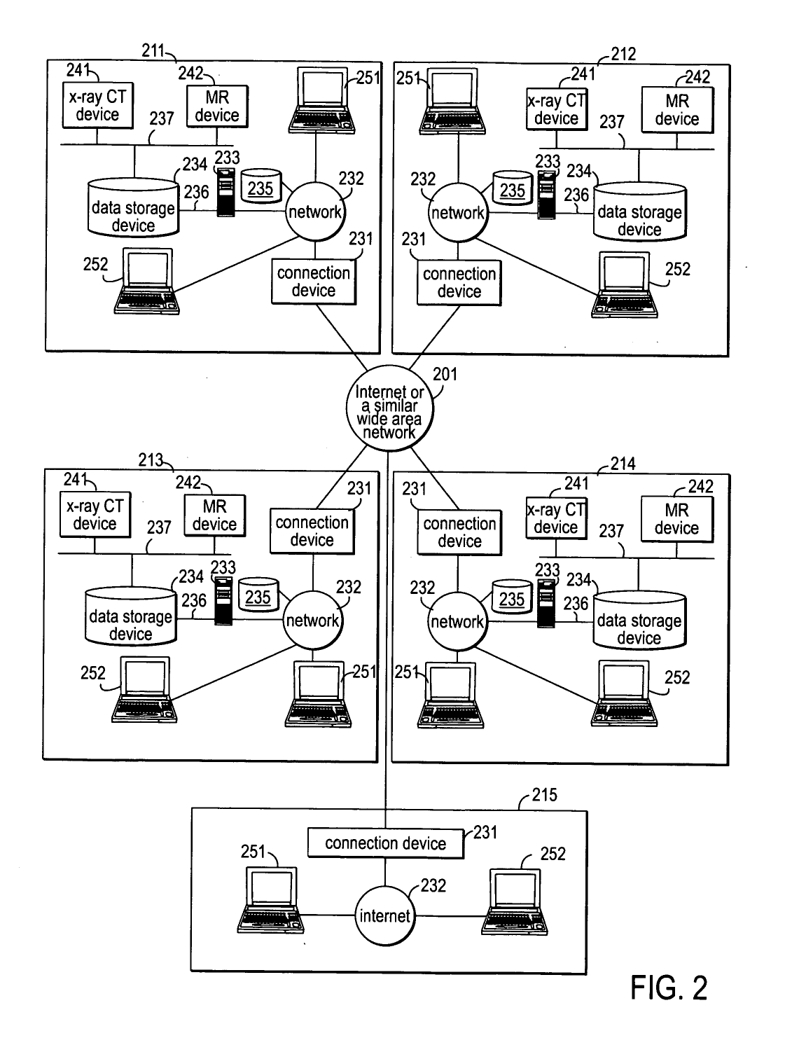

The following is an explanation of a system enabling creation and browsing of medical records in a wide network environment, as well as utilization of medical data. FIG. 2 is a block diagram explaining the network environment of image diagnoses devices, data collection devices, and data processing devices in a main hospital and in diagnostic locations according to this invention, as well as personal computers which are used as terminal device in order to browse and create medical records.

Number 201 designates a wide area network such as the Internet. Numbers 211, 212, 213, 214, 125 are medical treatment institutions, wherein 211, 212, 213 and 214 are main hospitals, while 215 is presumably a diagnostic treatment location. Medical treatment institutions 211, 212, 213, 214, 215 are connected to the wide area network 201. 231 is a connection device which connects the wide area network to the internal network of the medical treatment institutions, and number 232 indicates an internal medical treatment institution network. Number 233 is a data processing device, 234 is a data storage device for medical imaged data, in this case a PACS server, 235 is a medical treatment information server for medical treatment information such as image diagnosis reports and the like (hereinafter called HIS server), 236 is a high-speed network which connects data processing devices with data storage devices, and 237 is high-speed network for image data. Numbers 241, 242 indicate examples of image diagnosis devices.

251, 252 are examples of personal computers which are used as terminal devices to create and display electronic medical records and to display images.

An X-ray CT device 241, being one example of an image diagnosis device, collects X-ray projection data from multiple profiles (slices) of an examined subject, so that image data is created with multiple profiles when image reconstruction processing operations are applied to this X-ray projection data. PACS server 234 stores image data created when images are collected and reconstructed with multiple image diagnosis devices starting from the X-ray CT device 241, so that this image data is then transferred to users as required. Network 237 is a large capacity and high speed network which is used to transmit large amounts of image data from the X-ray CT device 241 to the PACS server 234. When the data processing device 233 acquires image data which is stored at the PACS server 234, image processing is applied to this image data and two-dimensional, three-dimensional, and four-dimensional images are created. Medical image diagnosis specialists who perform image diagnosis operations use personal computers 251, 252 to display the specification of medical image data and image processing parameters sent to the data processing device 233.

When the data processing device 233 acquires specified image data from the PACS server 234, image processing operations specified for this image data are performed, images are created and the created images are then transferred to personal computers 251, 252. In this manner, image diagnosis specialists can specify image data by using personal computers 251, 252, so that this imaged data can be used to create and observe two-dimensional images, as well as to image and observe three-dimensional images and four-dimensional images.

FIG. 2 illustrates a case when an image diagnosis specialist performs an image diagnosis at a medical treatment institution 211. This can be carried out in the same manner also at the medical treatment institution 212, as well as at the medical treatment institution 213 and medical treatment institution 214. The patient's X-ray CT image data, which is recorded with the X-ray CT device 241, is then sent by the network 237, which is a PACS server, and stored in the data storage device 234. An image diagnosis specialist performs an image diagnosis, the X-ray CT image data of the patient in question is stored by using personal computer 251, so that the X-ray CT image data of the patient can be transmitted as specified information to a data processing device 233, deployed near the network of the PACS server 234. The information relating to the X-ray CT-image data of this patient is acquired as X-ray CT image data from the PACS server based on the information which has been received by the data processing device 233, and image processing operations are conducted and images are created based on instructions relating to image processing, which have been received by using personal computer 251 by the image diagnosis specialists, and the created images are sent to personal computer 251. When the personal computer 251 receives the images, the images are displayed. The images displayed on the personal computer 251 are then viewed and observed by an image diagnosis specialist, who can modify image processing parameters when this is desirable, and when this data is sent to the data processing device 233, the image processing parameters can be changed again, so that the created images can be received after image processing operations have been performed with updated image processing parameters.

As an example of images obtained as a result of image processing and of processed image data, for example, when two-dimensional image processing is conducted during image processing applied to X-ray CT image data, while in another example, processing of three-dimensional images is applied to gray scale images which have 256 tone gradations and which have been obtained as a result of window processing applied to the X-ray CT image data with 16 bits, volume rendering is applied to multiple items containing 16 bit X-ray CT image data so that color images or the like are created with 256 RGB gradations from the obtained results.

When an image diagnosis specialist performs image processing, views two-dimensional images and creates and observes three-dimensional images, an image diagnosis report is created for an electronic medical record by using the personal computer 251 based on the findings obtained in this manner. Key images which represent the basis for the finding of the image diagnosis report are attached at this point to the electronic medical record. In addition, a set of parameters used for image processing in order to create images, which will represent a basis for the finding of an image diagnosis report in an electronic medical report, is also attached to the electronic medical report. Parameters specifying key images selected in this manner from a large amount of image data, image processing parameters which are used to display this image data in an optimal mode, and parameters used to created three-dimensional images are also included in this data.

Electronic medical records created by medical image specialists are stored in a medical treatment information server (HIS server) 235, which stores medical treatment information such as electronic medical records, while at the same time, a requesting party will either distribute information to request destinations via an internal institutional network if this party is present inside the same hospital, or the information can be distributed via IC cards or similar off-line medium for recorded information. If the requesting party is in another medical treatment institution, electronic medical records can be distributed either in an encrypted format to personal computers, which are used for browsing and preparation of electronic medical reports and connected via the Internet or the like, or information recorded in an electronic medical record can be recorded in an encrypted formed on an off-line recording medium such as an IC card and then mailed.

While FIG. 2 shows a case in which number 215 designates an institution where a request originated, the same is applicable also to medical treatment institution 211, medical treatment institution 212, medical treatment institution 213, and medical treatment institution 215. The medical doctor in charge will then browse electronic medical records which have been distributed by using personal computer 251 or personal computer 252. In order to access the electronic medical records from these personal computers, authentication must be received with an authentication system using an IC card, etc.

When a medical doctor in charge at the institution where a request originated browses electronic medical records by using the personal computer 251, the information relating to the image data attached to the electronic medical records can be sent together with a set of parameters for processing of images by clicking on a key image attached to the electronic medical record from the personal computer 251 to the data processing device 233 of the request destination institution 211. When the data processing device 233 receives this information, image data is acquired from the PACS server 234, image processing is applied to this image data and images are created, these images are encrypted and sent to the personal computer 251 which is used to browse and create electronic medical records at the request origination institution 215. The personal computer 251 for browsing and creating electronic medical records at the institution 215 where a request originated will receive these encrypted image, decode these images and display them. In addition, when updated image processing parameters are sent to the data processing device 233 of the request destination institution 211, images can be received so that they are processed with newly updated parameters for image processing, which have been updated in an interactive manner. Accordingly, this makes it possible to achieve a deeper understanding of the content of an image diagnosis report.

Because according to this invention, image processing of two-dimensional, three-dimensional and four-dimensional images requiring a large amount of data is performed in a concentrated manner on data processing devices deployed with a PACS server which stores this image data, and because the images obtained as a result of this image processing are sent through a wide area network and distributed to personal computers which are used for browsing and preparation of electronic medical records at the institution where a request originated, the traffic in the wide area network will not be increased very much.

The same medical treatment facilities are included both at the institution where a request originates and at the request destination institutions. In this case, an internal network is generally used at a medical treatment institution instead of using a wide area network such as the Internet.

Also in this case it is possible to greatly reduce the amount of traffic generated in the internal network of the medical treatment institution.

The information relating to image data which is attached to a report and the set of parameters for image processing will include the following parameters.

1) Parameters specifying the patient,

2) Parameters specifying image data,

3) Parameters used to perform image processing,

4) Parameters used to display images.

Among these parameters, data relating to item 1) are in some cases omitted due to privacy issues, so that image data pertaining only to information described in item 2) will be specified.

The case explained below pertains to the situation when a diagnostic record is created at a medical treatment institution with sequential recording in an electronic medical report, when an individual patient receives a diagnosis, which is given to the patients on a transportable medium such as an IC card. As shown in FIG. 2, when number 211 is in this case a medical treatment institution representing a destination for a request, 212 is a medical treatment institution in which a patient received a diagnosis in the past, 213 is also a medical treatment institution in which a patient received a diagnosis in the past, and 215 is a institution where a request originated, a doctor in charge at the institution 215 where a request originated browses data by using the personal computer 251 or the personal computer 252 to browse electronic medical records, which have been distributed from the request destination medical treatment institution 211. At this time, because this patient has received in the past a diagnosis at the medical treatment institution 212, key information was at that time attached to the electronic medical record, so that by clicking on this key information, the image data of the image examination obtained when the patient was examined at the medical treatment institution 212 can be accessed and the relevant information can be displayed. In addition, if this patient has received in the past a diagnosis at the medical treatment institution 213, key information was at that time attached to the electronic medical record, so that by clicking on this key information, the image data of the image examination obtained when the patient was examined at the medical treatment institution 213 can be accessed and the relevant information can be displayed. Moreover, if this patient has received in the past a diagnosis at the medical treatment institution 214, key information was at that time attached to the electronic medical record, so that by clicking on this key information, the image data of the image examination obtained when the patient was examined at the medical treatment institution 214 can be accessed and the relevant information can be displayed. Therefore, because it is possible to use data from medical image examinations conducted when a diagnosis was received in the past, even when a patient received medical diagnoses at different medical treatment institutions, it is not necessary to perform another image examination, so that the exposure of the patient to medical procedures can be decreased, and also the economical factors of the medical treatment can be improved.

Although the explanation provided up until now related to a case where a set of image processing parameters was attached to an electronic medical record and used to create images representing a basis for an image diagnosis, in another embodiment of this invention, identifiers of image processing parameters are attached to an electronic medical records, and image processing parameter sets corresponding to these parameters are stored in the PACS server 234 or in the HIS server 235. In this case, only identifiers of image processing parameter sets will be attached to an electronic medical record. The PACS server 234 or HIS server 235 will then store identifiers of parameters for image processing, which have been attached to respective electronic medical records, and the image processing parameter sets which correspond to these identifiers, and the identifiers of the image processing parameter sets attached to respected electronic medical records at the institution where a request originated are then distributed on-line through the wide-area network 201, or off-line, recorded on IC cards or similar media.

When a user at the institution where a request originated browses electronic medical records by using personal computer 251 or personal computer 252 for browsing and preparation of electronic medical records, respective attached identifiers of image processing parameter sets are sent to the data processing device 233 of the request destination institution. The data processing station which has received the identifiers of image processing parameter sets will then transmit these identifiers to the PACS server 234 or to the HIS server 235, and image processing parameters corresponding to these identifiers will be acquired from the PACS server or from the HIS server. The data processing device will read from the PACS server the image data specified based on these image processing parameters, and processing of two-dimensional, three-dimensional or four dimensional images is performed based on the image processing parameters and images are created, and the created images are sent to personal computers for browsing and preparation of electronic medical reports at the institution where a request originated.

At the personal computers for browsing and preparation of medical records, the images sent from the data processing station are displayed together with the medical records. The parameters used for processing of images are obtained at the personal computers for browsing and preparation of medical records are changed as necessary via data processing devices which are used to parameter for displaying of images, and updated parameters are sent to the data processing devices. The data processing devices perform processing of images with these updated image processing parameters and the result is sent to the personal computers for browsing and preparation of medical records. These operations can be conducted repeatedly and in an interactive manner. In addition, the updated parameters can be also stored at the PACS server or at the HIS server.

A medical specialist who performs an image diagnosis not only examines images that have been prepared for a given occasion, but also interprets these images by comparing them to other image examinations. When, for example, blood vessel imaging is performed during an image diagnosis, images obtained with X-ray CT scans and MRI scans are referenced at the same time and a comprehensive diagnosis is carried out. The information contained in these related image scans represents very important data for doctors at the institution where a request originated. According to this invention, sets of image processing parameters can be attached to medical records together with image data information, making it possible not only to access the present image scan, but also to create images which can be accessed in image scans, and key images of other image scans. While it was explained in the configuration described thus far that image data was accessed by an image diagnosis specialist in related image scans and referenced during an image diagnosis, because images can be created and image data information can be attached to medical records with image data information and image processing parameters, the images of desired image scans can be browsed by sending to a data processing device image processing parameters together with the image data information of the desired related image scans from the information described in the reports by a doctor in the institution where a request originated who is browsing medical records.

A medical specialist who performs an image diagnosis will interpret images not only by interpreting the data in the current image scans, but also by using for reference past image scans of a given patient. For example, when an image diagnosis report is created and a blood vessel imaging scan if performed, not only blood vessel image scans that were performed in the past, but also images from past X-ray CT scans and MRI scans are referenced. Information from past image scans therefore represents data that is important for doctors at the institution where a request originated. According to this invention, not only the present images scans, which are the main subject of an image diagnosis, but also key images from past image scans and the relevant image data can be accessed and images can be created, and image data information can be added to a medical record with a set of parameters for image processing. A doctor at the image origination institution can therefore browse a desired image by sending to a data processing device a set of image processing parameters with the image data information of past scans, which can be attached to an electronic medical record.

An image diagnosis specialist who performs an image diagnosis will interpret images from image scan data obtained not only as scan data obtained as data from physical examinations of a patient and similar scan data, but he will also consult the data in the medical history of the patient and other data. According to this invention, it is possible to attach to electronic medical records sets of parameters for processing of information, as well as to access information relating to medical treatment information which can be displayed so that a visible system can be accessed containing not only information from image scans, but also the data of related examinations, as well as medical history data and similar data. Because data from examinations and medical history data is generally distributed at a medical treatment institution by the person in charge at the HIS, HIS terminals must be normally used to search and browse the examination data. According to this invention, a doctor at the institution where a request originated, who is browsing medical records, can send to a data processing device at the request destination institution a set of parameters for information processing together with accessed information containing medical treatment data listed in a medical record. The data processing device then performs processing of information to create a visible system from the examination data and medical history data, data from physical examinations and other data obtained from HIS according to the accessed information relating to medical treatment data, which is then transmitted to personal computers for browsing and preparation of medical records that can be browsed in the medical electronic files. This makes it possible to browse desired data from medical histories or data from physical examinations.

According to this invention, personal computers for browsing and preparation of medical records can be used to examine current medical images, or to examine past images and to examine data from most recent and past examinations, when key images containing information that is useful to a user at an institution where a request for medical history information and other information originated is attached to a medical record. At the same time, because these image examinations, physical examination, image data from medical histories, or medical treatment information can thus be acquired, thanks to a function to enable attachment to key information contained in electronic medical records a set of parameters used for image processing and processing of information together with this information, and a set of parameters for data processing, thanks to a structure enabling to modify in a number of ways parameters with a parameter set for data processing, and a function to enable transmission of this data to a data processing device for data maintained and present at a server. When image data is received from a PACS server based on a set of image processing parameter, together with information relating to image data received by a data processing device, images are created by applying image processing to this image data, these images are transferred with a transfer function to personal computers for browsing and preparation of electronic medical records, data is acquired from HIS based on the received image acquisition information, and processing specified by this information is added, with a function to enable transmission to personal computers for browsing and preparation of electronic medical records. This makes it possible to display in an interactive manner information related to key information, as well as images related to these key images, which are attached to electronic medical records, so that this information can be displayed on personal computers for browsing and preparation of electronic medical records.

According to the method for distribution of electronic medical records to request origination institutions, personal computers for browsing and preparation of electronic medical records, or servers which store electronic medical records and create encryption of electronic medical records are equipped with a function to distribute encrypted electronic medical records to personal computers for browsing and preparation of electronic medical records, which are connected through a wide area network such as the Internet.

While an example has been explained which was equipped with a function to enable decoding of encrypted electronic medical records received by personal computers for browsing and preparation of electronic records, which are connected via a wide area network, personal computers for browsing and preparation of electronic records, which are connected via a wide area network such as the Internet, can be in some cases also equipped with a function to enable decoding of encrypted electronic medical records acquired from a server in which medical electronic data has been stored, or electronic medical records which have been created by personal computers for browsing and preparation of electronic medical records, as this function can be also provided in the same manner.

Personal computers for browsing and preparation of electronic medical records, or a server in which electronic medical records have been stored, are provided with a function to enable encryption of electronic medical records and to record this information on IC cards or the like. This also includes cases where the system is also equipped with a function to enable reading and decoding from a recording medium such as an IC card encrypted electronic medical records by personal computers for browsing and preparation of electronic medical records, which are connected via a wide are network such as the Internet.

When electronic medical records and medical images, or information from examinations and similar information created at a request destination institution relating to a patient is distributed to a request origination institution where this information originated, a system is needed which makes it impossible to access patient information by an unrelated party to protect the privacy of the patients when access to this patient information is requested at a request origination institution and at a request destination institution. According to an embodiment of this invention, an access control system is created with identification of user data through an IC card or the like of the personal computers 251, 252, and access is restricted so that no other party than a specified doctor can have access to the patient information. Cases when other privacy protection measures are used are also included in this invention.

Connection devices 231, deployed between a wide area network 201 and an internal network of an institution for medical treatment, limit access to prevent access through Internet, unless this has been enabled ahead of time according to the design of the medical institution for medical treatment.

When patient information is sent from a request destination medical treatment institution to a request origination medical treatment institution, the patient information is encrypted and at the same time, a design is created to prevent so-called “spoofing” with a design preventing patient information from being sent from the request origination medical treatment institution to a third party.

Multiple users can also use electronic medical records when conference operations are conducted. The electronic reports created in electronic records and prepared with personal computers for browsing and preparation of electronic medical records are distributed to addresses of doctors and other authorized parties who can access the system in request origination institutions, so that scheduling information can be added, which indicates the date and time when image diagnosis specialists who prepared the information and other persons can participate in a conference. When a doctor at a request origination institution who browses electronic medical records clicks on a link, for example an icon, to identify scheduling information or address information contained in an electronic medical record, an authorized party can thus be notified about the name and the schedule of the doctor, which makes it possible to plan a conference between multiple authorized parties. When the scheduling is finished, the main organizer of a conference can send an invitation to participants by using the address information contained in the electronic medical records. While the conference participants are conducting a teleconference, for example with a teleconferencing system, the conference can proceed based on image examination data, physical examination data, medical history data and other data relating to electronic medical records by using a plurality of user terminal devices.

Image examination data, data from physical information, or medical history data is thus selected from an attached electronic medical record with a personal computer for browsing and preparation of electronic medical records, and a set of parameters is transmitted to a data processing device. The data processing device performs acquisition and processing of the related data based on this set of parameters, and the results are sent to personal computers for browsing and preparation of multiple electronic medical records participating in a conference. The participants in a conference browse this data, change the parameters as required, and send the changed parameters to data processing devices, so that the conference can proceed in an interactive manner with multiple participants. For example, when the system is used by doctors who specialize in medical image diagnosis, multiple users can use the system by engaging jointly in processing of three-dimensional images by using the invention. Personal computers for browsing and preparation of electronic medical records are used to specify X-ray CT image data used to create three-dimensional images by using a set of parameters which are added to electronic medical records, and when parameters such as empty regions in the subject, or the range of CT values and other parameters are specified, and also projection processing parameters are specified in order to display three-dimensional images, related data is acquired based on the set of parameters by data processing devices and preparation of three-dimensional images is performed, so that when these created results are sent to multiple personal computers for browsing and preparation of electronic medical records, multiple users can participate jointly in the processing of three-dimensional images.

Data processing device apply image compression to these created two-dimensional, three-dimensional and four-dimensional images when the images are transmitted, and when the compressed images are received by personal computers for browsing and preparation of electronic medical records, two-dimensional, three-dimensional and four-dimensional images are decoded, so that even when a wide area network such as the Internet is used as a network connecting personal computers for browsing and preparation of electronic medical records to data processing devices, processing of two-dimensional, three-dimensional and four-dimensional images can thus be conducted in an interactive manner with personal computers for browsing and preparation of electronic medical records.

According to another embodiment, a user interface enabling modification of image processing parameters can be displayed on the screen by clicking on thumbnail images which are attached to electronic medical records, in a system equipped with a function to enable transmission to data processing devices image processing parameters that can be modified by these operations.

According to yet another embodiment, a window that is separate from the report is displayed with a user interface, which can be used to modify image processing parameters by clicking on thumbnail images attached to electronic medical records, in a system equipped with a function to enable transmission to data processing devices image processing parameters that can be modified by these operations.

Although it was explained in the example described thus far that X-ray CT image data was obtained from X-ray CT image devices, it is also possible to use the invention in a completely identical manner with image data obtained from MR devices, nuclear medicine device, ultrasound devices and other medical devices. In addition, the same functions can be also used with image data obtained from such medical imaging devices.

And although the term electronic medical records has been used thus far for explanation purposes, all other texts relating to patients created by a doctor, such as image diagnosis reports and the like are also included in electronic medical records.

### EFFECT OF THE INVENTION

Although there are systems for browsing of medical images which have been stored at a Web server by using a wide area network such as the Internet, in this case, these are images which have been created by applying image processing operations ahead of time to image data accumulated in devices for medical image diagnosis, such as X-ray CT devices and other devices for medical images stored at a Web server. In other words, these are images which have been created by applying image processing operations ahead of time and stored at a Web server, so that these images are acquired by a personal computer of a client and displayed.

Because in this case, the user acquires the images after the image processing operations have been completed, the user cannot freely modify the parameters for image processing. According to this invention, instead of browsing images which have been created when image processing operations were applied in advance to images stored at a Web server, image is data collected with image diagnosis devices such as X-ray CT devices specified by a client personal computer, and images are created by applying data processing with data processing device based on image processing parameters specified from a client personal computer, so that these newly created images are transmitted to the client personal computer, and the images are displayed when these images are received by the client personal computer. Therefore, the user can change the parameters for image processing in an interactive manner by using a client personal computer, so that the images which have been processed with these parameters for image processing can be displayed.

When a user who is in a location that is far away in terms of a network from a PACS server, which stores image data collected by medical image devices such as C-ray CT devices, wants to observe three dimensional images, created for example as three-dimensional images with three-dimensional image processing operations while the parameters for three-dimensional image processing were changed in an interactive manner and applied to image data stored in a PACS server, at the present time, such user needs to have available a workstation in order to perform image processing operations, the related image data must be transferred to the workstation used for image processing, while image data must be made available to the user from a PACS server which stores image data by using a wide area network such as the Internet. For example, when data is collected from as many as 2,000 profile images (slices) with 1 scan with the latest X-ray CT device, data corresponding to 10,000 MB must be in this case transferred. Because when a wide area network such as the Internet is used, an extremely long time period will be required due to different data transmission speeds, this will create an excessive amount of Internet traffic, and the network will be in the end continuously occupied, which means that it is essentially impossible to realize such an operation. That is why such image data is recorded on CD-R or the like and then sent by mail. This, however, also makes it impossible to realize preparation of three-dimensional images as required for a patient visiting a hospital unless this patient has scheduled a visit in advance. In addition, it is expensive to have workstations available for processing of images. According to this invention, because image processing is applied to image data and data processing device are deployed close to the PACS, in terms of the network, on which image data is present, the infrastructure does not pose any problems as far as performance of image processing operations is concerned. Moreover, because image processing can be realized with data processing devices in a concentrated manner, it is not necessary to provide expensive workstation for image processing for the user, as personal computers are fully compatible with their use for browsing of electronic medical records.

According to this invention, instead of transferring image data obtained during image examinations on a network connecting an institution where a request originated with an institution which is the destination for the request, only the information specifying the image data and the parameters applied to image processing are exchanged. According to prior art, because the user was utilizing medical image data obtained by imaging performed at the request origination institution at the request origination institution, a high speed network was required such as a dedicated line. This invention, however, makes it possible to use a wide area network such as the Internet for this purpose.

When the structure of a system of electronic medical records is created with a wide area network environment according to this invention for more than two medical institutions, including a medical institution that is entrusted with medical image examinations and a medical institutions that is requesting medical image examinations, without having to transfer very large amounts of image data from medical image examinations, which are stored at an institution for medical treatment being the request destination institution, from the request destination medical treatment institution to the request origination medical treatment institution, the doctors at the institution for medical treatment in which the request originated can use very large amounts of image data which are present at the request destination medical treatment institution, the processing of these images can be performed and the resulting images can be observed and an image diagnosis can be conducted. In other words, without having to move very large amounts of image data required for image examination, image processing operations can be conducted as if these large amounts of data were within reach for examination of medical images, and the results of the image examinations can be displayed. Therefore, this makes it possible to eliminate the time that was required in order to procure large amounts of image data for examination of medical images, and the network traffic can be greatly reduced.

Also, because image processing is conducted with data processing devices which are present at the institution of medical treatment in which the medical image data is stored, it is no longer necessary to set up workstations for image processing operations at the institution of medical treatment in which a request originated, making it possible to display images while image processing operations are conducted in an interactive manner with personal computers which are used for browsing of electronic medical records.

While doctors at medical treatment institutions, such as a diagnostic location from which a request was made for an examination of medical images, can browse electronic medical records created by image diagnosis specialists at an institution for medical treatment, such as a main hospital entrusted with these medical image examinations, the same image processing operations can be conducted by using image data stored at the request destination medical treatment institution, which were used at the time when the image diagnosis was performed by these image specialists. The images resulting from these image processing operations can thus be displayed and observed. Because of that, an interpretation of electronic medical records can proceed very quickly.

According to this invention, it has become possible to acquire key images representing a key for image diagnosis, but also image examinations created with other types of modality related to these images, as well as past image examinations, physical examinations, medical record information and other data and information. Data and other information are collected with a great deal of effort at the time when an image diagnosis is conducted. According to this invention, electronic medical records, which are collected in an intensive manner while the information contained in them, can be accessed by using all means and paths to access this information. In addition, even when a complete image management system is not available at a hospital, important data chosen from image data such as CT examinations performed during an image analysis, MR examinations, or DSA examinations can be acquired from various image management system controlling this data, so that when this data is accumulated at a PACS server, and information containing an important diagnosis issued by image specialists can be obtained with an electronic medical records at a later time. According to this invention, important information relating to a given patient can be obtained at any time not only by the actual image specialists who performed an image diagnosis, but also by other specialists, as well as by users at a request origination institution, who can obtain this information by browsing electronic medical records. In addition, because when a new image examination of this user is conducted, other information important for the interpretation of images used in an electronic medical record, such as past image examinations, physical examinations, medical history and other information can be accessed in a short time, a very useful system is created from the viewpoint of operability, in a system that is very economical.

The processing of one three-dimensional image can be performed jointly by a plurality of users, including image diagnosis specialists. An image diagnosis specialist specifies X-ray CT image data to be used in order to create a three-dimensional image and parameters such as the empty regions in the object or the range of the CT values are specified, and the resulting three-dimensional images are created by a data processing server so that when they are transmitted to a plurality of personal computers, multiple users can jointly perform processing of one three-dimensional image.

At the point when two-dimensional, three-dimensional, and four-dimensional images that have been created with a data processing device are transmitted, the image data is compressed and encrypted, and when decoding of the received two-dimensional, three-dimensional and four dimensional images is carried out, these two-dimensional, three-dimensional and four dimensional images can be handled and displayed correspondingly and in a practical, interactive manner at the terminal computer devices of the users, even if only a wide area network such as the Internet is used to connect data processing devices with the terminal computer devices of the users.

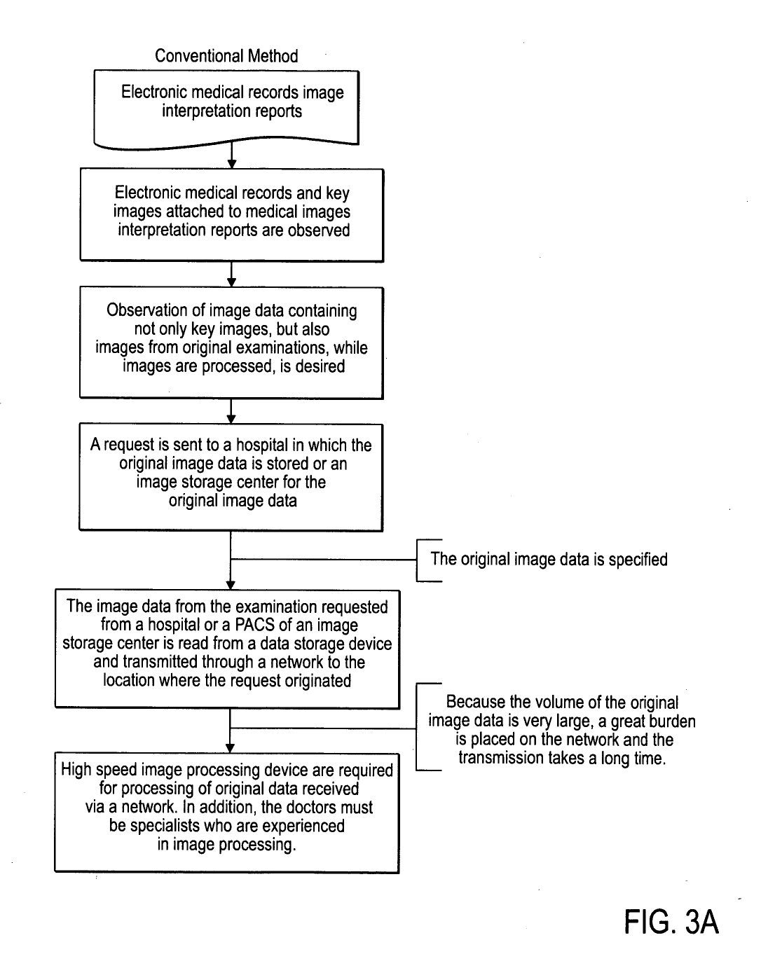

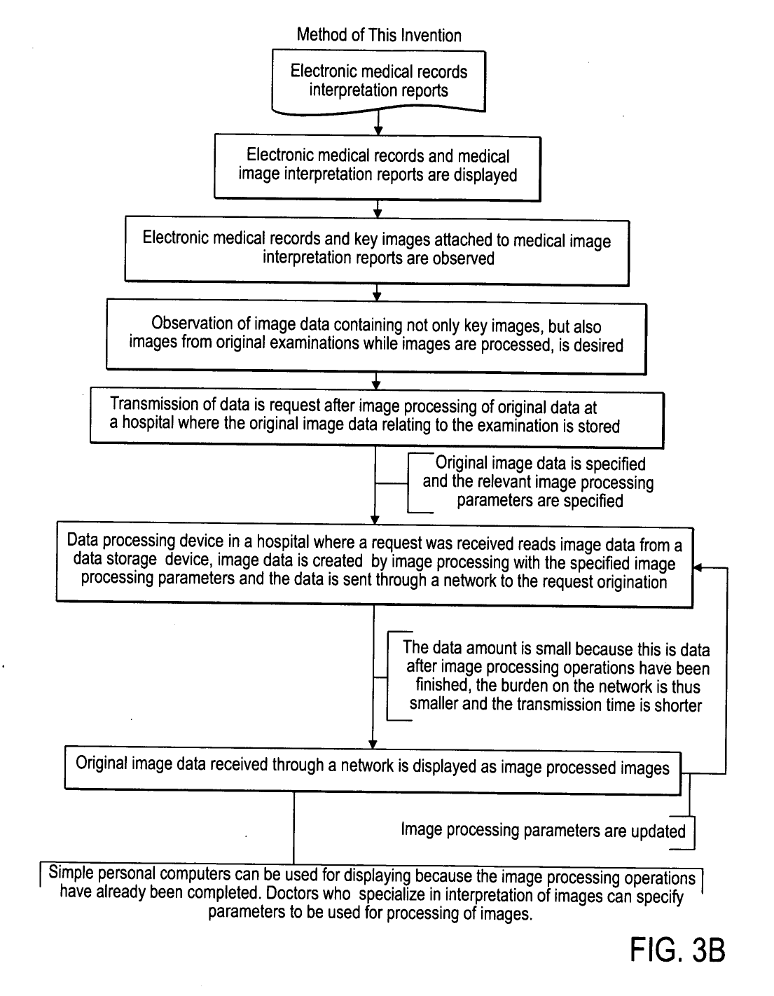

FIG. 3A is a block diagram showing the operations used at the point when a doctor at a request origination institution browses electronic medical records in a case using a conventional system. FIG. 3B is a block diagram showing the operations used at the point when a doctor at a request origination institution browses electronic medical records in a case when the present invention is used. Because according to prior art, image processing was conducted by using image data which has been stored at the medical treatment institution representing request destination, a doctor at institution where the request originated had to take possession of image data recorded on a recording medium or access via the Internet image data stored at the medical treatment institution where the request originated, he had to use a workstation available for image processing operations, and processing of images had to be applied to the image data with this workstation for image processing.

Since computers that were normally used for browsing and preparation of electronic medical records were personal computers, when image processing operations were applied to image data by doctors at the institution where the request originated, special workstations had to be purchased which were used only to perform image processing operations. According to this invention, when a doctor at the request origination institution wants to use a data processing device deployed at the request origination medical treatment institution and apply the device to image data stored at the request destination medical treatment institution, the image processing operations can be performed with desired image processing parameters. Therefore, according to this invention, it is no long necessary to set up special workstations to be used for image processing, while the amount of data that is transmitted in a wide area network can be greatly reduced at the same time.

When an electronic medical record is prepared for a patient with sequential recording of diagnostic records at a medical treatment institution in which the patient is diagnosed so that the record is provided in portable medium such as an IC card, the electronic medical record can be referenced at the time when this patient receives a diagnosis at an institution of medical treatment, together with other records created in the past at a hospital visited by this patient. When multiple institutions of medical treatment use the present invention, key information such as key images that were attached to an electronic medical record at the time when a patient was diagnosed at another medical treatment institution can be displayed by clicking on key information, the data contained in image of image examination which the patient received in the past at another medical treatment institution can be accessed and these images can be displayed. While such IC card systems were used in the past, it was practically impossible to access large amounts of data such as image examination data that was stored in other institutions for medical treatment. When the present invention is employed by multiple medical treatment institutions, it is now possible to create the architecture of a system that can be used to access large amounts of data, including not only the use of an IC card system, but also data from image examinations stored in other medical treatment institutions. Therefore, even if a patient has received a diagnosis in different institutions for medical treatment, data from examinations performed in the past can be utilized so that it is no longer necessary to perform another examination, which plays an important role in reducing the exposure of a patient to medical interventions, while the economical design of medical treatment is also improved.

Thus, a medical record system for use in a wide-area network environment has been described. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. An information system, comprising a medical image storage communication system (PACS) server, to store and transmit medical image data created with an image diagnosis device; data processing devices set up near a network of the PACS server; terminal devices to browse and create electronic medical records, equipped with a user authentication system for information from a plurality of medical treatment institutions; in an information system, mutually connected for dissemination and distribution of information on a wide area network, to an information system equipped with a user authentication system;
wherein the data processing devices are equipped with a function for acquisition from the PACS of image data displayed at terminal devices, the function being used to browse and prepare electronic medical records as a function used during the preparation of electronic medical records; including a function for preparation of images for image diagnosis, realized when image processing is applied to image data based on specified image processing parameters; and including a function enabling transmission of the images to the terminal devices;
wherein the data processing devices acquire image data from the PACS server based on information specified by the terminal devices with a function used during the browsing of electronic medical records; comprising a function to create images realized when image processing is applied to image data based on specified parameters for processing of images; a function to prepare images by applying image processing to the image data based on the specified parameters for image processing, and a transmitting function, to transmit to the terminal devices an encrypted system of compressed data with the images;
a function to specify parameters for processing of images applied to image data, specified as image data to be acquired from a PACS server by a data processing device, as a function used by a terminal device when electronic medical records are created; a function to display images received from the data processing devices; a function for recording in medical records the results of an image diagnosis performed based on the images;
a function to attach a medical diagnosis key and key images creating said key to an electronic medical record;
and a function to add to the key images a set of parameters for processing of images, together with access information applied to related image data in order to realize images used for an image diagnosis during browsing of electronic medical records;
wherein the terminal devices for browsing and preparation of electronic medical records are equipped with a function to specify image processing, applied to image data acquired as image data accessed by the data processing devices, which stores the relevant image data based on a set of parameters for processing of images, enabling access to information applied to the relevant image data when key images have been attached to electronic medical records; a function to receive images transmitted from the data processing devices and for displaying of the images;
a function to perform mutual authentication in an information system of institutions of medical treatment, which are connected through a wide area network to a user authentication system;
in a system using medical image data and browsing and preparation of electronic medical records in a wide area network, enabling display of interactively created images prepared with two-dimensional, three-dimensional, and four-dimensional image processing with the data processing devices deployed near the PACS server of an institution for medical treatment which stores the image data, using related key image data attached to an electronic medical record during the preparation of an electronic medical report at an institution for medical treatment, when an image diagnosis is performed of so far existing diagnoses of a patient, at a time when electronic medical records are browsed at a medical treatment institution at terminal devices for browsing and preparation of electronic medical records of institutions for medical treatment which are visited by patients.

2. A system as recited in claim 1, which makes it possible to acquire image data specified from the PACS server on the basis of a set of parameters received from the terminal devices, as a function used when electronic medical records are created by data processing device; equipped with a function to transmit to the terminal devices images created with specified image processing; and a function to enable transmission to the terminal devices visual information, wherein the specified processing has been added to information data acquired as information data specified by a hospital information system (HIS);
wherein the terminal devices are equipped with a function to add to electronic medical records a key as key information, and key images for information and images, creating a key to items such as past image scans, physical examinations, medical history information and other information creating key information and related information used during a diagnosis of images; a function to attach to key images and the key information of electronic medical records a set of parameters enabling processing of acquired information data and related image data during browsing of electronic medical records; a function to transmit to the data processing devices a set of added parameters enabling modification of several parameters in the structure of a parameter set added to the key information and key images which are added to electronic medical records, as a function used during the browsing of electronic medical records by the terminal devices; and a function to display the images and the information received as images and information transmitted from data processing devices;
wherein data are added relating to medical history information, physical examinations or past image examinations, as well as data related to the key information and key images attached to an electronic medical record when an electronic medical record is prepared at a medical treatment institution in which a patient has been examined, processed when electronic medical records are browsed at the terminal devices, which can be displayed interactively as a result of processing performed by the data processing devices which stores this data by a system for browsing and preparation of electronic medical records in a wide area network.

3. A system as recited in claim 2, wherein the terminal devices, connected through a wide area network, are equipped with a function to enable acquisition of encrypted electronic medical records from a server which stores electronic medical records, or from one of the terminal devices;
equipped with a function to provide the electronic medical records stored by a server, or by one of the terminal devices.

4. A system as recited in claim 2, equipped with a function to enable recordation on a recording medium, with a system safeguarding privacy, using encryption, electronic medical records archived by a server or by the terminal devices;
wherein the terminal devices, connected through a wide area network, are equipped with a function to enable reading from the recording medium electronic medical records, encrypted to protect privacy.

5. A system as recited in claim 2, wherein the terminal devices or a server which stores electronic medical devices is equipped with a function to distribute encrypted electronic medical records to terminal devices for browsing and preparation of electronic medical records, connected through a wide area network; and which a function to enable receipt of this data in the terminal devices connected via a wide area network.

6. A system as recited in claim 1, wherein the terminal devices, connected through a wide area network, are equipped with a function to enable acquisition of encrypted electronic medical records from a server which stores electronic medical records, or from one of the terminal devices;
equipped with a function to provide the electronic medical records stored by a server, or by one of the terminal devices.

7. A system as recited in claim 1, equipped with a function to enable recordation on a recording medium, with a system safeguarding privacy, using encryption, electronic medical records archived by a server or by the terminal devices;
wherein the terminal devices, connected through a wide area network, are equipped with a function to enable reading from the recording medium electronic medical records, encrypted to protect privacy.

8. A system as recited in claim 7, equipped with a function to enable display on a screen electronic medical records, with a user interface used to modify image processing parameters by clicking on key images attached to electronic medical records, and with a function to enable transmission to data processing devices a set of parameters for processing of images, which can be modified with the operation of the parameters.

9. A system as recited in claim 7, equipped with a function to enable transmission to data processing devices image processing parameters, which are modified by the operation of a user interface, wherein by clicking on key images attached to electronic medical records, a separate window is displayed for electronic medical records, enabling modification of image processing parameters.

10. A system as recited in claim 9, comprising image diagnostic records, in which electronic medical records are created as an electronic system.
